(19) United States
(12) Patent Application Publication
(10) Pub. No.: US 2019/0366526 A1
(43) Pub. Date: Dec. 5, 2019

(54) FLYWHEEL-DRIVEN SETTING DEVICE

(71) Applicant: HILTI AKTIENGESELLSCHAFT, Schaan (LI)

(72) Inventors: Dominik SCHMIDT, Feldkirch (AT); Tilo DITTRICH, Feldkirch (AT); Raphael THON, Wiener Neustradt (AT)

(21) Appl. No.: 16/461,584

(22) PCT Filed: Nov. 13, 2017
(86) PCT No.: PCT/EP2017/079046

§ 371 Date: Jun. 7, 2019

(30) Foreign Application Priority Data
Nov. 18, 2016 (EP) 16199461.1

(51) Int. Cl. B25C 1/06; B25F 5/00

(52) U.S. Cl. CPC B25C 1/06; F16F 15/30; B25F 5/00

(57) ABSTRACT

A flywheel-driven setting device for driving fastening elements into a base comprises at least one flywheel, which is directly driven by an electric motor. The electric motor is designed as a disk motor having at least one disk rotor.

### TECHNICAL FIELD

The invention relates to a flywheel-driven setting device for driving fastening elements into a base, comprising at least one flywheel, which is directly driven by an electric motor.

### STATE OF THE ART

An electrically driven driving-in device for fastening elements is known from the German published patent application DE 10 2005 000 077 A1, the device having a drive arrangement for a driving-in plunger mounted in a guide, in displaceable manner, which arrangement has at least one drive flywheel that can be put into rotation by way of an electric motor, and having a reset device, by way of which the driving-in plunger can be returned to a starting position. A fastening means driving-in tool is known from the European patent EP 2 127 819 B1, set up for driving fastening means into a workpiece, the tool comprising at least one electric motor having a center stator and an outer rotor, which is set up for rotating about the stator, wherein at least part of the rotor comprises the flywheel.

### PRESENTATION OF THE INVENTION

It is the task of the invention to create a flywheel-driven setting device for driving fastening elements into a base, having at least one flywheel that is driven directly by an electric motor, which device has a good efficiency and a long service life.

This task is accomplished, in the case of a flywheel-driven setting device for driving fastening elements into a base, having at least one flywheel that is driven directly by an electric motor, in that the electric motor is designed as a disk motor having at least one disk rotor. The flywheel-driven setting device is preferably a manually guided setting device, which is also called a setting tool. The fastening elements are nails or bolts, for example, which are driven into the base using the setting device, which is also called a setting tool. It is advantageous if the setting energy is made available by way of the electric motor, and transferred to a driving-in element, which is also called a setting piston, by way of the flywheel. For this purpose, the flywheel is put into rotation by the electric motor. The rotation energy of the flywheel is transferred to the driving-in element, in particular the setting piston, which is also called a piston, for short, for the setting procedure. The fastening element is driven into the base using the driving-in element, in particular the piston. The flywheel is connected with the driving-in element by friction contact, for example using a suitable coupling device, so as to transfer the rotation energy from the flywheel to the driving-in element. For this purpose, the driving-in element can be disposed between the flywheel and a counter-roller. After a setting procedure, the driving-in element is released from the flywheel by opening the coupling device. Then the driving-in element can be returned to its starting position by means of a suitable reset device, for example a spring device. It is advantageous that the construction space for the flywheel drive can be configured to be very small by means of designing the electric motor as a disk motor. This relatively small flywheel drive can easily be integrated into a manually guided setting device. Direct drive of the disk rotor by means of the electric motor has the advantage that undesirable losses in efficiency are avoided. The disk rotor of the disk motor can be effectively cooled during operation of the setting device, in simple manner. After the setting device is turned on, the disk motor is quickly ready for use and can transfer high torques using the disk rotor. As a result, acceleration of the disk rotor from a stopped position is made possible in simple manner. This brings with it the advantage that the flywheel-driven setting device having the disk motor is quickly ready for operation.

A preferred exemplary embodiment of the flywheel-driven setting device is characterized in that the disk rotor is designed as a flywheel. As a result, production and assembly of the setting device are significantly simplified. It is advantageous that the mass of the disk rotor is utilized as an oscillating weight during operation of the setting device.

A further preferred exemplary embodiment of the flywheel-driven setting device is characterized in that the disk rotor is provided with permanent magnets, which interact with stator windings. It is advantageous if the coil windings are disposed relatively far outward in the radial direction. This brings with it the advantage that the heat that occurs in the coil windings during operation can be directly given off to the surroundings and does not accumulate in the interior of the electric motor. As a result, the flywheel mass can be effectively increased in simple manner.

A further preferred exemplary embodiment of the flywheel-driven setting device is characterized in that the disk rotor is connected with a rotor shaft, forming at least one annular cavity. The annular cavity is represented, for example, by crosspieces and/or spoke-like connections between the flywheel and the rotor shaft. The rotor shaft serves for rotatably mounting the disk rotor relative to a fixed stator of the electric motor, designed as a disk motor. By means of the annular cavity, a large part of the flywheel mass can be advantageously displaced into regions of the disk rotor that lie radially outward. As a result, the efficiency of the flywheel is improved. Furthermore, the weight of the flywheel can be reduced as compared with a disk rotor that does not have an annular cavity. In turn, the total weight of the flywheel-driven setting device can be advantageously reduced as a result.

A further preferred exemplary embodiment of the flywheel-driven setting device is characterized in that the disk rotor can be rotated between two symmetrically arranged stator devices. The two stator devices represent a disk motor having a double stator. It is advantageous if the stator devices essentially have the form of disks, like the disk rotor. However, the stator devices are fixed in place, in comparison with the disk rotor. The disks that represent the stator devices preferably have a lesser thickness than the disk rotor. The expanse of the stator devices in the axial direction is referred to as the thickness. The term axial relates to the axis of rotation of the disk rotor. The symmetrical structure of the stator devices provides the advantage that no axial forces are exerted on the disk rotor during operation.

A further preferred exemplary embodiment of the flywheel-driven setting device is characterized in that a stator device is fixed in place between two disk rotors, which are each designed as a flywheel and arranged symmetrically. The two disk rotors represent a disk motor having a double rotor. It is advantageous if permanent magnets are affixed to the disk rotors. The disk rotors can have bell-shaped convexities, just like the single disk rotor described above, which serve for fixing the permanent magnets in place in the radial direction relative to the respective disk rotor. As a result, undesirable release of the permanent magnets during rotation of the disk rotor is prevented in simple manner. In spite of the stator device that lies on the inside, sufficient cooling of the disk motor can be ensured by means of a relatively large air gap between the disk rotor and the stator devices.

A further preferred exemplary embodiment of the flywheel-driven setting device is characterized in that the disk rotor/the disk rotors comprises/comprise coil windings, which interact with permanent magnets of the stator device/stator devices. As a result, an embodiment of the disk motor as a direct-current motor with permanent magnets is made possible.

A further preferred exemplary embodiment of the flywheel-driven setting device is characterized in that the disk rotor/disk rotors and the stator device/stator devices comprise coil windings. As a result, en embodiment of the disk motor as a series-wound motor, in particular a double series-wound motor is made possible. It is advantageous if the magnetic field is built up by way of the coil windings.

A further preferred exemplary embodiment of the flywheel-driven setting device is characterized in that a or the rotor shaft is mounted outside of the stator device/stator devices and of the disk rotor/disk rotors in the axial direction. The rotor shaft is rotatably mounted in a fixed support structure of the setting device, for example, using suitable mounting devices.

A further preferred exemplary embodiment of the flywheel-driven setting device is characterized in that the disk motor comprises Hall sensors for detecting a flywheel position and/or a flywheel speed of rotation. Individual stator windings can be electronically controlled as a function of a rotor position of the disk rotor or of the disk rotors by way of the data recorded using the Hall sensors, so as to drive the disk motor.

The invention also relates to a method for operating a flywheel-driven setting device as described above, if applicable.

The invention also relates to a disk rotor and/or to a stator device for a setting device as described above, if applicable. The said parts can be commercially obtained separately.

Further advantages, characteristics, and details of the invention are evident from the following description, in which different exemplary embodiments are described in detail, making reference to the drawing. The figures show:

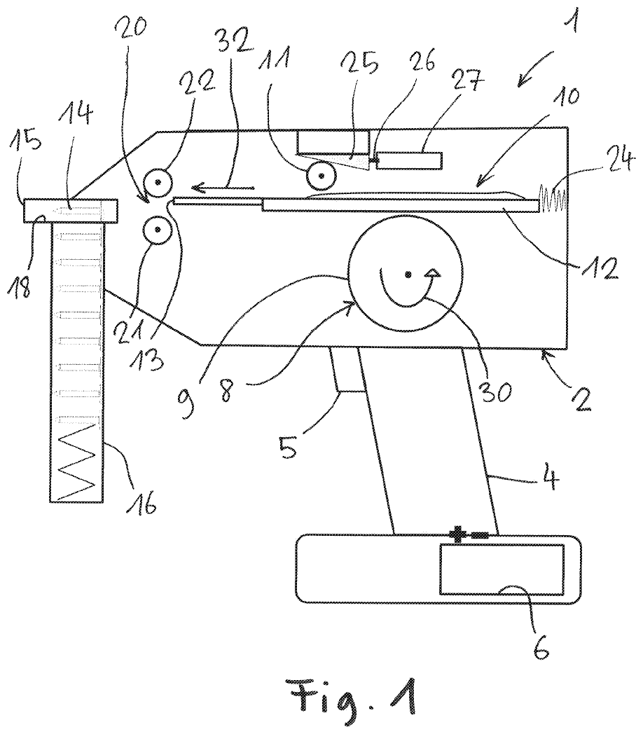

FIG. 1, a simplified representation of a flywheel-driven setting device that has a flywheel, which is directly driven by an electric motor designed as a disk motor;

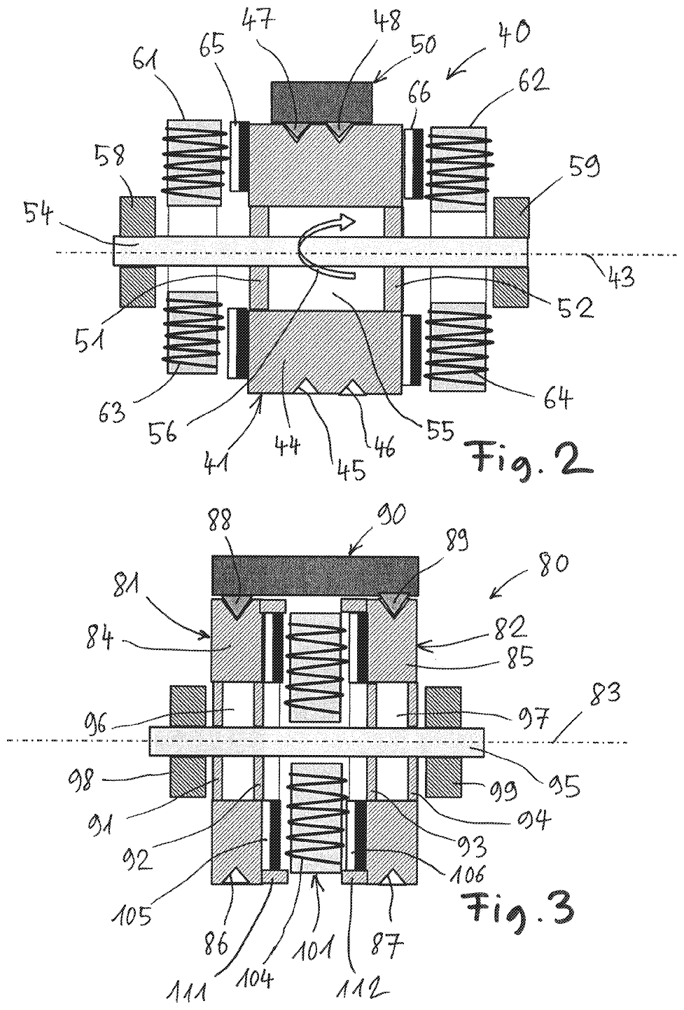

FIG. 2, a simplified representation of an exemplary embodiment of the flywheel drive, having a disk motor that comprises a disk rotor, which can rotate between two stator devices, in longitudinal section, and

FIG. 3, a flywheel drive having a disk motor, according to a second exemplary embodiment, with a stator device that is arranged between two disk rotors, also in longitudinal section.

### EXEMPLARY EMBODIMENTS

In FIG. 1, a flywheel-driven setting device 1 having a housing 2 is shown in simplified manner. The housing 2 has a handle 4 with a trigger 5. For this reason, the setting device 1 is also called a manually guided setting device or setting tool.

A rechargeable battery 6 for storing electrical energy is integrated into a lower free end of the handle 4 of the setting device 1 in FIG. 1. The electrical energy of the rechargeable battery 6 serves for driving an electric motor 8, which is designed as a disk motor. A flywheel 9 is directly driven using the disk motor 8. It is advantageous if the flywheel 9 is designed as a disk rotor of the disk motor 8. The flywheel 9 can be put into rotation quickly and with high torque, by way of the disk motor 8.

The setting device 1 furthermore comprises a driving-in element 10 having a setting piston 12, which is also referred to as a piston, for short. The driving-in element 10 or the setting piston 12 is arranged between the flywheel 9 and a counter-roller 11. The counter-roller 11, with the flywheel 9 and the driving-in element 10 arranged in between, can also be designed as a helical gear coupling, contrary to what is shown.

The setting piston 12 has a piston tip 13 on its left end in FIG. 1, with which tip a fastening element 14 can be driven into a base (not shown) at the setting end 15 of the setting device 1. The fastening elements 14 are bolts or nails, for example, which are made available, preferably automatically, at the setting end 15 of the setting device 1, by way of a magazine 16. The fastening element 14 arranged in the magazine 16 in FIG. 1, at the top, is guided in a bolt guide 18.

The setting piston 12 or the driving-in element 10 is guided so that it can be moved in the axial direction, in other words to the left and to the right in FIG. 1, in the setting device 1, using at least one piston guide 20. The piston guide 20 comprises two guide rollers 21, 22. To drive the fastening element in, the setting piston 12 is moved toward the fastening element 14 at great acceleration with its piston tip 13, by means of the piston guide 20. After a setting procedure, the setting piston 12 is moved back into its starting position, shown in FIG. 1, using a reset spring 24.

The setting device 1 furthermore comprises a wedge 25, which can be moved with a plunger 26, by means of an electromagnet 27, so as to press the counter-roller 11 downward against the driving-in element 10 in FIG. 1. As a result, a type of coupling is represented, which serves for connecting the driving-in element 10 with the flywheel 9, with friction contact.

As soon as friction contact has been produced, a rotational movement of the flywheel 9, which movement is indicated with an arrow 30 in FIG. 1, is transferred to the driving-in element 10, so that the latter is moved to the left toward the fastening element 14, in the bolt guide 18, in a setting direction, also indicated by an arrow 32 in FIG. 1. As soon as the driving-in element 10 hits the fastening element 14 with the piston tip 13, the element is driven into the base at the setting end 15 of the setting device 1.

In FIGS. 2 and 3, two exemplary embodiments of disk motors 40; 80 are shown, which show how the electric motor 8 can be designed in particularly advantageous manner for driving the flywheel 9 of the setting device 1 in FIG. 1. In the case of reduced construction space, sufficiently great setting energy can be made available by means of the flywheel drive having the disk motor 40; 80, which energy is transferred to the driving-in element 10 by way of the flywheel 9.

The rotor motor 40 shown in FIG. 2 comprises a disk rotor 41, which represents the flywheel 9 in FIG. 1. The disk rotor 41 can rotate about an axis of rotation 43. To represent the flywheel, the disk rotor 41 comprises a flywheel body 44. The flywheel body 44 has two annular grooves 45, 46 radially on the outside, into which grooves wedge ribs 47, 48 engage. The wedge ribs 47, 48 are formed on an underside of a driving-in element 50, which corresponds to the driving-in element 10 in FIG. 1. The production of friction contact between the driving-in element 50 and the flywheel or the disk rotor 41 is simplified or improved by means of the wedge ribs 47, 48, which can be brought into engagement with the annular grooves 45, 46.

The flywheel body 44 is connected with a rotor shaft 54, in torque-proof manner, by way of crosspieces 51, 52, which are shown as examples. In this way, an annular cavity 55 is represented in advantageous manner. The annular cavity 55 is delimited radially on the outside by the flywheel body 44. Radially on the inside, the annular cavity 55 is delimited by a rotor shaft 54. In the axial direction, the annular cavity 55 is delimited by the crosspieces 51, 52.

A rotational movement of the rotor shaft 54 together with the flywheel body 44 is indicated by an arrow 56. The rotor shaft 54 is mounted by means of mounting devices 58, 59, so as to rotate, on the outside in the axial direction, in other words on the left and on the right in FIG. 2. The mounting devices 58, 59 are preferably arranged in the setting device so that they are fixed in place on the housing.

The disk rotor 41 is arranged between two stator devices 61, 62 in the axial direction. The stator devices 61, 62 are arranged and designed symmetrically. To represent the disk motor 40, the fixed stator devices 61, 62 are provided with coil windings 63, 64, which are also called stator windings. The coil windings 63, 64 interact with permanent magnets 65, 66, which are fastened onto the disk rotor 41. The disk rotor 41 can also be formed from the permanent magnets 65, 66, in whole or in part.

The disk motor 40 with the two stator devices 61, 62 on both sides of the disk rotor 41 yields the advantage, due to its symmetrical structure, that no axial forces are exerted on the disk rotor 41 during operation. It is advantageous if the disk motor 40 is equipped with Hall sensors (not shown). The stator windings 63, 64 can be individually controlled by way of the signals detected using the Hall sensors, so as to put the disk rotor 41 into rotation.

The disk motor 80 shown in FIG. 3 comprises two disk rotors 81, 82, which can jointly rotate about an axis of rotation 83. The disk rotors 81, 82 each comprise a flywheel body 84, 85, similar to the disk rotor 41 in FIG. 2.

The flywheel bodies 84, 85 each have an annular groove 86, 87 radially on the outside. For production of friction contact, wedge ribs 88, 89 engage into the annular grooves 86, 87. The wedge ribs 88, 89 are formed on an underside of a driving-in element 90, which element corresponds to the driving-in element 10 in FIG. 1.

For representation of an annular cavity 96, 97, the flywheel bodies 84, 85 are connected with a common rotor shaft 95 by way of crosspieces 91, 92; 93, 94, in torque-proof manner. The annular cavities 96, 97 have the same function in the disk rotors 81, 82 as the annular cavity 55 of the disk rotor 41 in FIG. 2.

The rotor shaft 95 is mounted axially outside of the disk rotors 81, 82, so as to rotate, using mounting devices 98, 99 that are fixed in place on the housing. A stator device 101 is arranged between the disk rotors 81, 82, fixed in place in the axial direction. The stator device 101 is equipped with coil windings 104, which are also called stator windings 104. The coil windings 104 interact with permanent magnets 105, 106, which are fastened onto the disk rotors 81, 82.

The disk rotors 81, 82 are equipped with circumferential crosspieces 111, 112, radially on the outside, for representation of bell-shaped convexities for fixation of the permanent magnets 105, 106. The circumferential crosspieces 111, 112 are firmly connected with the flywheel bodies 84, 85, and fix the permanent magnets 105, 106 in place radially on the outside.

The two disk rotors 81, 82 of the disk motor 80 represent a double rotor with a stator lying on the inside. The flywheel, which is shown from the inside, is divided into two parts by means of the two disk rotors 81, 82. The driving-in element 90 engages into both disk rotors 81, 82 with the wedge ribs 88, 89.

The construction shown in FIG. 3 offers the advantage, at very high accelerations and speeds of rotation, among other things, that the permanent magnets 105, 106 of the disk rotors 81, 82 are held in stable manner on or in the flywheel bodies 84, 85, in spite of high centrifugal forces.

1. A flywheel-driven setting device for driving fastening elements into a base, comprising at least one flywheel, which is directly driven by an electric motor, wherein the electric motor is a disk motor having at least one disk rotor.

2. The flywheel-driven setting device according to claim 1, wherein the at least one disk rotor is a flywheel.

3. The flywheel-driven setting device according to claim 1, wherein the at least one disk rotor is provided with permanent magnets, magnets, which interact with stator windings.

4. The flywheel-driven setting device according to claim 1, wherein the at least one disk rotor is connected with a rotor shaft, forming at least one annular cavity.

5. The flywheel-driven setting device according to claim 1, wherein the at least one disk rotor can rotate between two symmetrically arranged stator devices.

6. The flywheel-driven setting device according to claim 1, further comprising a stator device that is fixed in place between two disk rotors, each designed as a flywheel and arranged symmetrically.

7. The flywheel-driven setting device according to claim 5, wherein the at least one disk rotor comprises coil windings, which interact with permanent magnets of the stator device.

8. The flywheel-driven setting device according to claim 5, wherein the at least one disk rotor and the stator device comprise coil windings.

9. The flywheel-driven setting device according to claim 1, further comprising a rotor shaft and a stator device wherein the rotor shaft is mounted outside of the stator device and of the at least one disk rotor in an axial direction.

10. The flywheel-driven setting device according to claim 1, wherein the disk motor comprises Hall sensors for detecting a flywheel position and/or a flywheel speed of rotation.

11. The flywheel-driven setting device of claim 6, wherein the disk rotors comprise coil windings which interact with permanent magnets of the stator devices.

12. The flywheel-driven setting device of claim 6, wherein the disk rotors and the stator devices comprise coil windings.

13. The flywheel-driven setting device according to claim 2, wherein the at least one disk rotor is provided with permanent magnets, which interact with stator windings.

14. The flywheel-driven setting device according to claim 2, wherein the at least one disk rotor is connected with a rotor shaft, forming at least one annular cavity.

15. The flywheel-driven setting device according to claim 3, wherein the at least one disk rotor is connected with a rotor shaft, forming at least one annular cavity.

16. The flywheel-driven setting device according to claim 2, wherein the at least one disk rotor can rotate between two symmetrically arranged stator devices.

17. The flywheel-driven setting device according to claim 3, wherein the at least one disk rotor can rotate between two symmetrically arranged stator devices.

18. The flywheel-driven setting device according to claim 4, wherein the at least one disk rotor can rotate between two symmetrically arranged stator devices.

19. The flywheel-driven setting device according to claim 2, further comprising a stator device that is fixed in place between two disk rotors, each designed as a flywheel and arranged symmetrically.

20. The flywheel-driven setting device according to claim 3, further comprising a stator device that is fixed in place between two disk rotors, each designed as a flywheel and arranged symmetrically.
